(19) United States
(12) Patent Application Publication
(10) Pub. No.: US 2015/0216001 A1
(43) Pub. Date: Jul. 30, 2015

(54) An LED Lighting System

(71) Applicant: Acorntech Limited, Saratoga, CA (US)

(72) Inventors: Kenneth Y. Mok, Sunnyvale, CA (US); Minh Quang Tran, San Jose, CA (US); David D. Tsang, Los Altos, CA (US); Chungjen Chien, Saratoga, CA (US)

(73) Assignee: Acorntech Limited, Saratoga, CA (US)

(21) Appl. No.: 14/164,105

(22) Filed: Jan. 24, 2014

(51) Int. Cl. H05B 33/08

(52) U.S. Cl. CPC H05B 33/083; H05B 33/0827

(57) ABSTRACT

An LED lighting system comprises: lighting blocks; and one or more switches, wherein electrical connections between the lighting blocks are configured using the one or more switches, and wherein the one or more switches are operated as a function of an input voltage. Based upon the input voltage to the LED lighting system, the electrical connections of the lighting blocks can be configured accordingly.

### FIELD OF INVENTION

This invention generally relates to a lighting system, and, in particular, to a configurable LED lighting system.

### BACKGROUND

Light emitting diodes (“LEDs”) lighting systems, e.g., LED lamps, LED bulbs, and other LED lighting systems, are commonly powered by direct current (“DC”) voltages. Since many households use alternating current (“AC”) voltages to power devices and systems, LED lighting systems may require converters for switching the AC power supply to an acceptable input voltage for the respective LED lighting systems.

One obstacle in powering LED lighting systems with AC voltages is that the AC voltages can vary depending on the region of the LED lighting systems. In particular, different regions can supply differing AC voltages for use in powering devices. For instance, 120V AC voltage is supplied to households in the United States. Other countries provide around 220V to 240V AC voltage to consumers. Therefore, there exists a need for providing an LED lighting system that is more energy efficient than conventional LED lighting systems. Furthermore, there exists a need for providing an LED lighting system that can be driven by a wide range of AC voltages. Even more so, there exists a need for providing an LED lighting system that can be used across various regions and is configurable for use with a range of AC voltages.

### SUMMARY OF INVENTION

An object of this invention is to provide a lighting system that can be configured to adapt to various input voltages.

Another object of this invention is to provide an efficient lighting system that can be driven by an AC voltage.

Yet another object of this invention is to provide a lighting system having modular lighting blocks, where the lighting blocks are configurable depending upon the input voltage.

Briefly, the present invention discloses an LED lighting system comprising: lighting blocks; and one or more switches, wherein electrical connections between the lighting blocks are configured using the one or more switches, and wherein the one or more switches are operated as a function of an input voltage.

An advantage of this invention is that a lighting system is provided that can be configured to adapt to various input voltages.

Another advantage of this invention is that an efficient lighting system is provided that can be driven by an AC voltage.

Yet another advantage of this invention is that a lighting system is provided having modular lighting blocks, where the lighting blocks are configurable depending on the input voltage.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIG. 1 illustrates a diagram of a configurable LED lighting system of the present invention.

FIG. 2 illustrates a table of states for switches of an LED lighting system of the present invention.

FIGS. 3a-3e illustrate equivalent block circuits for various configurations of an LED lighting system of the present invention.

FIG. 4 illustrates a diagram of a lighting block of the present invention.

FIGS. 5a-5d illustrate various input voltages for an LED lighting system of the present invention plotted on a graph.

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced.

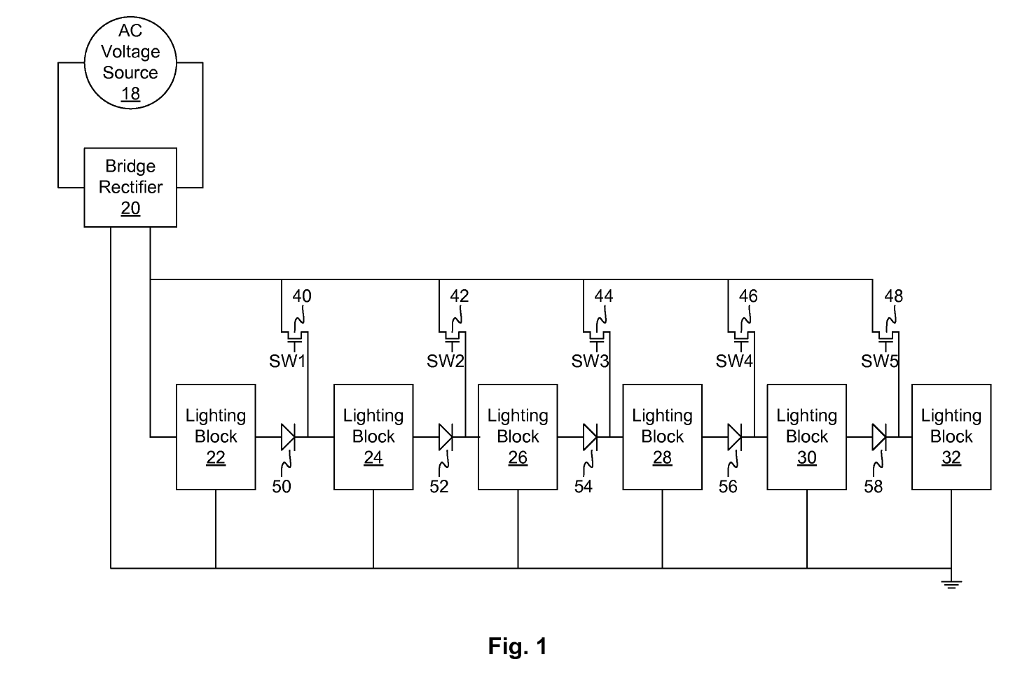

FIG. 1 illustrates a configurable LED lighting system of the present invention. Generally, electrical power supplies in various applications range anywhere from 100V-480V of alternating current. A lighting system of the present invention can be configured to adjust to the electrical power supply. The configurable lighting system of the present invention comprises an alternating current (“AC”) voltage source 18, a bridge rectifier 20, lighting blocks 22-32, switches 40-48, and diodes 50-58. The switches 40-48 can be implemented by a variety of transistors, e.g., PMOS, NMOS, etc. The blocking diodes can be implemented by conventional diodes, switches operated as diodes, or other equivalent circuits/elements. A person having ordinary skill in the arts can appreciate that a variety of circuit elements and circuits can be used to implement such components and concepts disclosed in the present invention.

The AC voltage source 18 (e.g., a wall socket, or other power source) can provide an AC voltage to the bridge rectifier 20. The bridge rectifier 20 transforms the AC voltage to a rectified voltage Vr (e.g., a half sine wave DC voltage or other variable direct current voltage). The rectified voltage Vr is an input voltage to the lighting block 22 and the switches 40-48. The lighting blocks 22-32 are serially connected via the diodes 50-58. The lighting block 22 is connected to the lighting block 24 via the diode 50. The lighting block 24 is connected to the lighting block 26 via the diode 52. The lighting block 26 is connected to the lighting block 28 via the diode 54. The lighting block 28 is connected to the lighting block 30 via the diode 56. The lighting block 30 is connected to the lighting block 32 via the diode 58. The bridge rectifier 20 and the lighting blocks 22-32 are connected to ground (or a low voltage potential for the lighting system).

The diodes 50-58 block current such that current flow through the serially-connected lighting blocks 22-32 is one way along the serial connection. The diodes 50-58 can be referred to as blocking diodes to prevent voltage kickback. The diode 50 has a first end connected to the lighting block 22 and a second end connected to the lighting block 24, and only allows current to flow from the lighting block 22 to the lighting block 24. The diode 52 has a first end connected to the lighting block 24 and a second end connected to the lighting block 26, and only allows current to flow from the lighting block 24 to the lighting block 26. The diode 54 has a first end connected to the lighting block 26 and a second end connected to the lighting block 28, and only allows current to flow from the lighting block 26 to the lighting block 28. The diode 56 has a first end connected to the lighting block 28 and a second end connected to the lighting block 30, and only allows current to flow from the lighting block 28 to the lighting block 30. The diode 58 has a first end connected to the lighting block 30 and a second end connected to the lighting block 32, and only allows current to flow from the lighting block 30 to the lighting block 32.

The switch 40 connects the rectified voltage Vr from the bridge rectifier 20 to the second end of the diode 50. A control voltage SW1 can be inputted to the gate of the switch 40 to turn on and off the switch 40. When the switch 40 is on, the rectified voltage Vr is applied to the second end of the diode 50 via the switch 40 (assuming an ideal switch operation). When the switch 40 is off, the switch 40 cuts off all current through the switch 40, serving as an open connection.

The switch 42 connects the rectified voltage Vr from the bridge rectifier 20 to the second end of the diode 52. A control voltage SW2 can be inputted to the gate of the switch 42 to turn on and off the switch 42. When the switch 42 is on, the rectified voltage Vr is applied to the second end of the diode 52 via the switch 42. When the switch 42 is off, the switch 42 cuts off all current through the switch 42, serving as an open connection.

The switch 44 connects the rectified voltage Vr from the bridge rectifier 20 to the second end of the diode 54. A control voltage SW3 can be inputted to the gate of the switch 44 to turn on and off the switch 44. When the switch 44 is on, the rectified voltage Vr is applied to the second end of the diode 54 via the switch 44. When the switch 44 is off, the switch 44 cuts off all current through the switch 44, serving as an open connection.

The switch 46 connects the rectified voltage Vr from the bridge rectifier 20 to the second end of the diode 56. A control voltage SW4 can be inputted to the gate of the switch 46 to turn on and off the switch 46. When the switch 46 is on, the rectified voltage Vr is applied to the second end of the diode 56 via the switch 46. When the switch 46 is off, the switch 46 cuts off all current through the switch 46, serving as an open connection.

The switch 48 connects the rectified voltage Vr from the bridge rectifier 20 to the second end of the diode 58. A control voltage SW5 can be inputted to the gate of the switch 48 to turn on and off the switch 48. When the switch 48 is on, the rectified voltage Vr is applied to the second end of the diode 58 via the switch 48. When the switch 48 is off, the switch 48 cuts off all current through the switch 48, serving as an open connection.

It is understood that the number of switches and the number of lighting blocks can be adjusted as needed in accordance with the present invention. A person having ordinary skill in the art can understand that based on the disclosure of the present invention other configurations and equivalent circuits are possible. For illustrative purposes, five switches and six lighting blocks are illustrated in FIG. 1. However, it is not meant in any way to limit the present invention to the illustrated embodiment since other configurations can be contemplated by a person having ordinary skill in the art based on the present invention. Additionally, the lighting blocks of the present invention can be other circuits and/or elements. For instance, the lighting blocks can be other types of loading blocks, where the loading blocks can comprise resistive circuit elements and/or other elements that provide an electrical load.

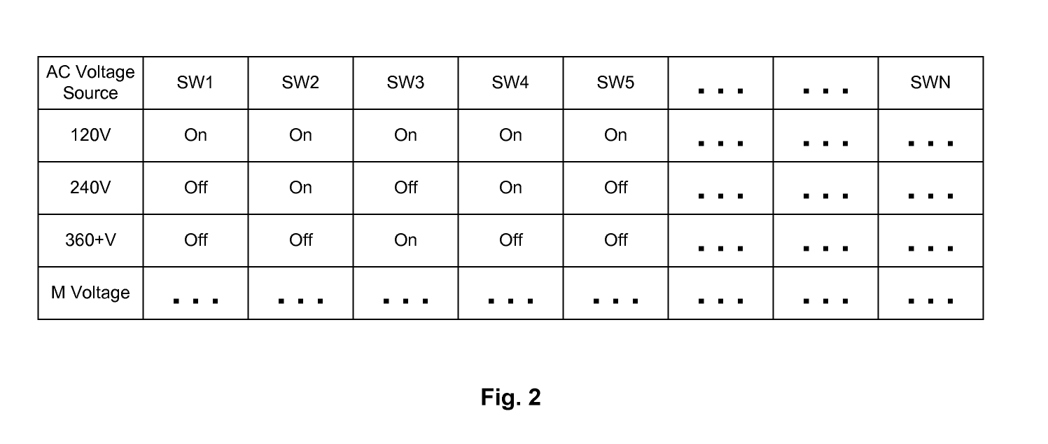

FIG. 2 illustrates a table of states for switches of the LED lighting system of the present invention. The LED lighting system, illustrated in FIG. 1, can be configured according to AC voltage source 18 (and consequently the rectified voltage Vr, which is also a function of the AC voltage source 18). Depending on the AC voltage source 18, the electrical current can be routed through lighting blocks 22-32 serially and/or in parallel. The configurations can be selected by turning on or off the switches 40-48.

For example, for an AC voltage source of around 120V, the switches 40-48 can receive control signals SW1-SW5, respectively. The control signals SW1-SW5 are set to a first predefined voltage (“On”) to turn on the switches 40-48. Thereby, each of the lighting blocks 24-32 is connected to the rectified voltage Vr via the switches 40-48. Since the diodes 50-58 are disposed between the serial connections of the lighting blocks 22-32, current cannot flow in a reverse direction from the diodes 50-58 even though the rectified voltage Vr is applied to the second end of the diodes 50-58 via the switches 40-48.

In such operating state, the lighting blocks 22-32 are effectively connected in parallel across the rectified voltage Vr and ground. Thus, the electrical current paths can be the following: current passing through the lighting block 22 to the ground; current passing through the switch 40, then through the lighting block 24, and finally to the ground; current passing through the switch 42, then through the lighting block 26, and finally to the ground; current passing through the switch 44, then through the lighting block 28, and finally to the ground; current passing through the switch 46, then through the lighting block 30, and finally to the ground; and current passing through the switch 48, then through the lighting block 32, and finally to the ground.

In this example, the voltage drop across each of the lighting blocks is around the amount of the rectified voltage (e.g., 120V). However, it is understood that other combinations of lighting blocks can be used and each of the lighting blocks can have various voltage drops from each other in accordance with the present invention.

For an AC voltage source of around 240V, the control signals SW2 and SW4 are set to the first predefined voltage On to turn on the switches 42 and 46. Thus, each of the lighting blocks 26 and 30 is connected to the rectified voltage Vr via the switches 42 and 46.

Since the diodes 52 and 56 are disposed between the respective serial connections, current cannot flow in a reverse direction from the diodes 52 and 56 even though the switches 42 and 46 are connected to the second end of the diodes 52 and 56.

The control signals SW1, SW3, and SW5 are set to a second predefined voltage (“Off”) to turn off the switches 40, 44 and 48. Thereby, current can flow from the lighting block 22 to the lighting block 24 via the diode 50, from the lighting block 26 to the lighting block 28 via the diode 54, and from the lighting block 30 to the lighting block 32 via the diode 58.

In such operating state, the lighting blocks 22-32 are effectively connected in three branches in parallel across the rectified voltage Vr and ground, wherein each branch has two lighting blocks. Thus, the electrical current paths can be the following: current passing through the lighting block 22 to the lighting block 24 via the diode 50, and finally to the ground; current passing through the switch 42, through the lighting block 26, then through the lighting block 28 via the diode 54, and finally to the ground; current passing through the switch 46, through the lighting block 30, then through the lighting block 32 via the diode 58, and finally to the ground.

In this example, the voltage drop across each of the lighting blocks is around the amount of the voltage (e.g., 120V). The voltage drop across each branch can be 240V. However, it is understood that other combinations of lighting blocks can be used and each of the lighting blocks can have various voltage drops from each other in accordance with the present invention.

For an AC input voltage of around 360V, the control signal SW3 is set to the first predefined voltage On to turn on the switch 44. Thus, the lighting block 28 is connected to the rectified voltage Vr via the switch 44. Since the diode 54 is disposed between the serial connection of the lighting blocks 26 and 28, current cannot flow in a reverse direction from the diode 54 even though the switch 44 is connected to the second end of the diode 54.

The control signals SW1, SW2, SW4, and SW5 are set to the second predefined voltage Off to turn off the switches 40, 42, 46 and 48. Thereby, current can flow from the lighting block 22 to the lighting block 24 via the diode 50, and further to lighting block 26 via the diode 52. Furthermore, current can flow from the lighting block 28 to the lighting block 30 via the diode 56, and further to the lighting block 32 via the diode 58.

In such operating state, the lighting blocks 22-32 are effectively connected in two branches in parallel across the rectified voltage Vr and ground, wherein each branch has three lighting blocks. Thus, the electrical current paths can be the following: current passing through the lighting block 22 to the lighting block 24 via the diode 50, next to the lighting block 26 via the diode 52, and finally to the ground; and current passing through the switch 44 to the lighting block 28, then to the lighting block 30 via the diode 56, and then to the lighting block 32 via the diode 58, and finally to the ground.

In this example, the voltage drop across each of the lighting blocks is around the amount of the voltage (e.g., 120V). The voltage drop across each branch is around 360V since each branch is configured to have three lighting blocks electrically connected in series. However, it is understood that other combinations of lighting blocks can be used and each of the lighting blocks can have various voltage drops from each other in accordance with the present invention.

Based on the present invention, various configurations can be known to a person having ordinary skill in the art to account for a variety of AC input voltages. The examples of the present disclosure are not meant to limit the present invention in any way. In fact, a lighting system of the present invention can use a multiple number of switches and lighting blocks in accordance with the present invention as a function of the AC voltage source. For instance, assuming the following for a lighting system of the present invention: (1) the voltage drop across each of the lighting blocks is a predefined voltage M, i.e., M volts; (2) there are N number of lighting blocks; (3) there are N−1 number of switches; and (4) there are N−1 number of blocking diodes, the lighting system can be configured to receive input voltages of M volts, 2M volts, . . . , or NM volts.

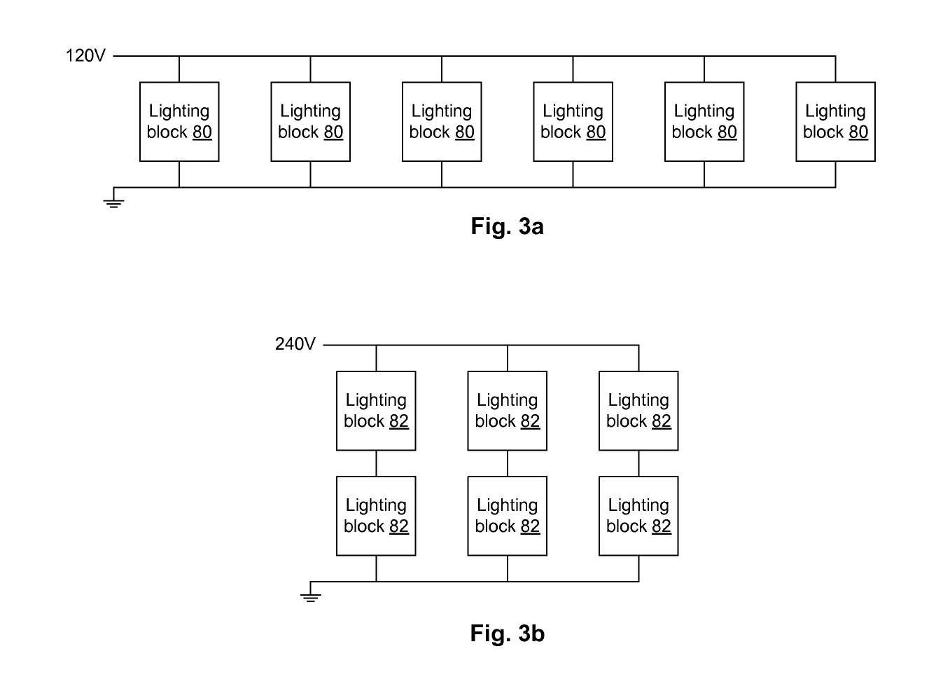

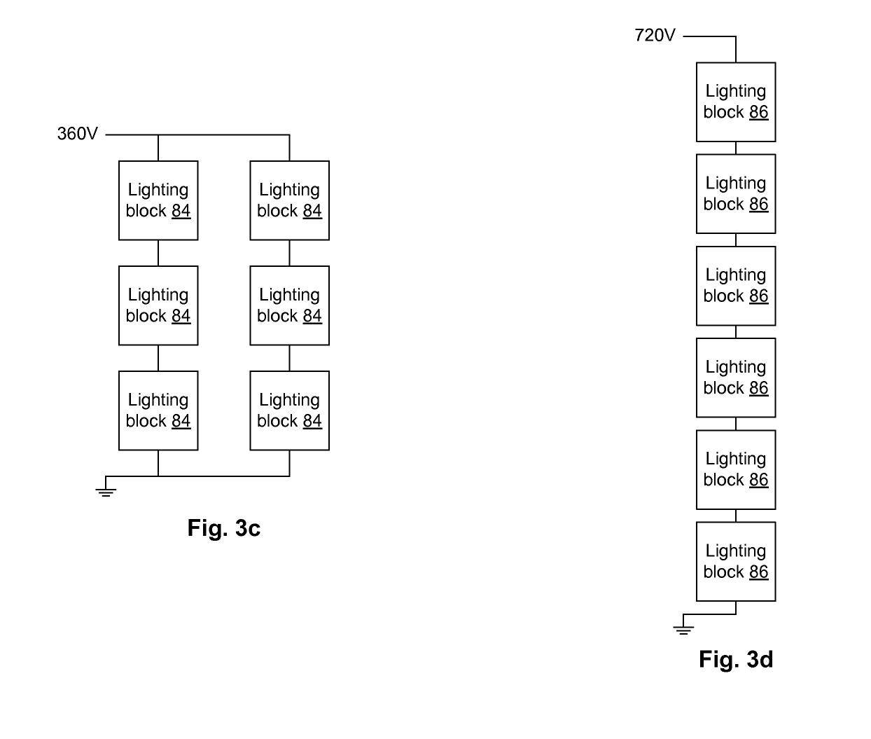

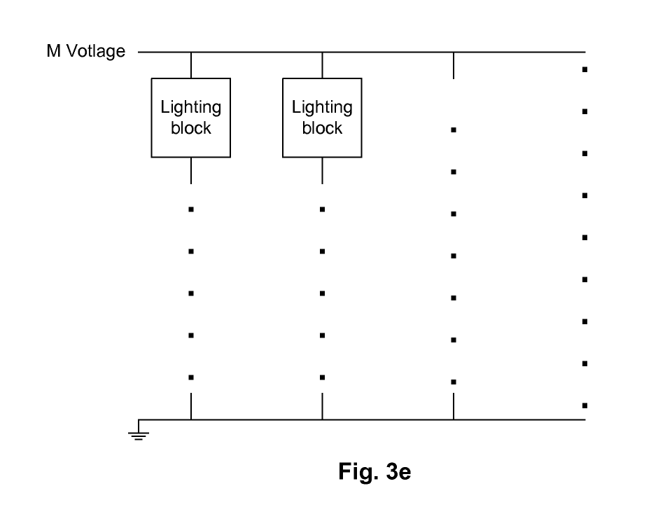

FIGS. 3a-3e illustrate equivalent block circuits for various configurations of an LED lighting system of the present invention.

FIG. 3a illustrates lighting blocks electrically connected in parallel. If an LED lighting system of the present invention has an AC voltage source of about 120V, lighting blocks 80 of the LED lighting system can be electrically connected in parallel using the switches of the LED lighting system as mentioned above.

FIG. 3b illustrates lighting blocks electrically connected in three parallel branches. If an LED lighting system of the present invention receives an AC voltage source of about 240V, lighting blocks 82 of the LED lighting system can be electrically connected in three parallel branches using the switches of the LED lighting system as mentioned above. Each of the three branches can have two of the lighting blocks 82 connected in series.

FIG. 3c illustrates lighting blocks electrically connected in two parallel branches. If an LED lighting system of the present invention provides an AC voltage source of about 360V, lighting blocks 84 of the LED lighting system can be electrically connected in two parallel branches using the switches of the LED lighting system as mentioned above. Each of the two branches can have three of the lighting blocks 84 connected in series.

FIG. 3d illustrates lighting blocks electrically connected in series. If an LED lighting system of the present invention has an AC voltage source of about 720V, lighting blocks 86 of the LED lighting system can be electrically connected in series by having the switches of the LED lighting system off.

FIG. 3e illustrates lighting blocks electrically connected in series and/or parallel. Due to the modularity of the lighting system of the present invention, the lighting blocks of the present invention can be connected in series and/or in parallel to receive the input voltage M. A person having ordinary skill in the art can appreciate that there are many configurations that can be used for the present invention. Also, it's understood that the voltage drop across each lighting block can vary as well. Therefore, it is not the intention to limit the present invention to the illustrated figures.

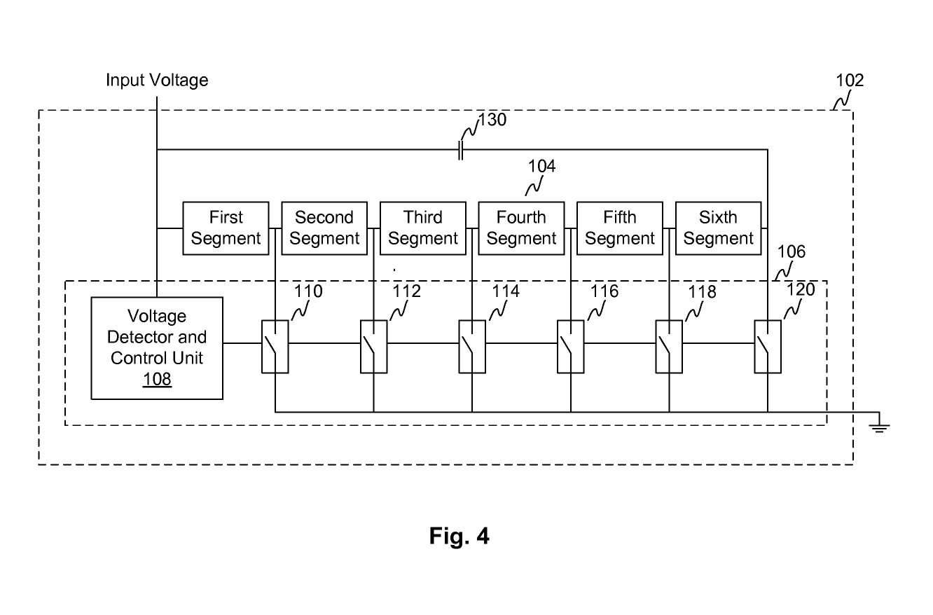

FIG. 4 illustrates a lighting block of the present invention. A lighting block of the present invention 102 can comprise serially-connected segments of LED arrays 104, a voltage detector and control unit 108, constant current switches 110-120, and one or more capacitors 130. The voltage detector and control unit 108 and the constant current switches 110-120 can be collectively referred to as an LED control unit 106.

The LED arrays 104 are illustrated by a first segment, a second segment, a third segment, a fourth segment, a fifth segment, and a sixth segment, where each of the segments can comprise an LED array of LEDs connected in series and/or in parallel, or can alternatively be a single LED. It is understood by a person having ordinary skill in the art that the LED arrays 104 can be arranged in other configurations, including in parallel, or in combination of parallel and serial. The illustration in FIG. 4 is not meant to limit the present invention since other configurations can be formed by a person having ordinary skill in the art based on the present invention.

The LED control unit 106 activates one or more segments of the LED arrays 104 as a function of the input voltage. The capacitors 130 can discharge energy when the input voltage is low to prevent flickering of the LED arrays 104. The capacitors 130 are an optional element.

The voltage detector and control unit 108 detects the input voltage, and turns on a number of segments of the LED arrays 104 that can be driven by the amount of input voltage. For instance, if each segment of the LED arrays 104 can handle a 20V voltage drop to drive the respective segment and the input voltage is 60V, then the first three segments of the LED arrays 104 can be activated and the last three segments of the LED arrays 104 can be deactivated via the current switches 110-120. It is understood that each segment of the LED arrays 104 can have different number of LEDs and different voltage drops across each one of the LEDs of the LED arrays.

Since the input voltage is a rectified voltage of the AC voltage source, the segments of the LED arrays 104 are automatically activated or deactivated to correspond to the varying input voltage. Each segment of the LED arrays 104 can be turned on sequentially as the input voltage increases to preset values to drive the LED arrays 104 of the activated segments. Likewise, as the input voltage decreases, the segments of the LED arrays 104 can be sequentially turned off. The preset values can depend on the amount of voltage drop across each of the segments. For each segment of the LED arrays 104 that is turned on, the input voltage should be high enough to drive that segment's LEDs and any previous segment's LEDs.

In other embodiments of the present invention, the segments of the LED arrays 104 can be turned on in a preselected order, rather than sequentially. For instance, additional switching mechanisms can be used to maintain that one or more certain segments of the LED arrays 104 are on, and/or the segments of the LED arrays 104 can be activated (i.e., turned on) or deactivated (i.e., turned off) according to the preselected order.

The input voltage is connected to a first end of the serially-connected segments of the LED arrays 104. The voltage detector and control unit 108 can detect the input voltage and select which one of the constant current switches 110-120 to turn on. Since the input voltage is a rectified voltage Vr of the AC voltage source, the input voltage will vary anywhere from around zero volts to a peak voltage Vpeak depending on the magnitude and frequency of the AC voltage source.

As the input voltage rises from its lowest value (e.g., around 0V) to its peak value (e.g., around 170V for a 120V AC voltage source), the constant current switches 110-120 can be sequentially turned on to match this rise in voltage. When a certain one of the constant current switches 110-120 is activated, the other ones of the constant current switches are deactivated such that the certain one of the constant current switches provides an electrical path to ground. Each one of the constant current switches 110-120 that are turned on can provide a current pass to the ground. Thereby, the serially-connected segments of the LEDs 104 are sequentially turned on to match the increasing rectified voltage Vr.

Additionally, the constant current switches 110-120 can also be sequentially turned on in a reverse order when the input voltage lowers from the peak voltage Vpeak to its lowest voltage. Similarly, when a certain one of the constant current switches 110-120 is activated in the reverse order to match the decreasing peak voltage Vpeak, the other ones of the constant current switches are deactivated such that the certain one of the constant current switches provides an electrical path to ground. Each of the constant current switches 110-120 that are turned off block the respective current pass to the ground. Thereby, the serially-connected segments of the LEDs 104 are sequentially turned off to match the decreasing rectified voltage Vr.

The LED arrays 104 can be grouped into six segments of LED arrays for this example. However, any number of segments or individual LEDs and/or LED arrays can be used in accordance with the present invention. Furthermore, each segment may have a differing number of LEDs, depending on the total amount of voltage drop designed for the respective segment.

When the constant current switch 110 is activated and the constant current switches 112-120 are deactivated, a predefined amount of current (e.g., around 100 mA) is drawn through a first segment of the LED arrays 104 to ground. When the constant current switch 110 is deactivated, an electrical current can run through the first segment to one or more of the remaining segments of the LED arrays 104, depending on which one of the constant current switches 112-120 is activated.

When the constant switch 112 is activated and the constant current switches 110 and 114-120 are deactivated, the predefined amount of current (e.g., around 100 mA) is drawn through the first segment of the LED arrays 104, a second segment of the LED arrays 104, and then to ground. When the constant current switches 110 and 112 are deactivated, an electrical current can be routed through the first segment and second segment of the LED arrays 104 to one or more remaining segments of the LED arrays 104, depending on which one of the constant current switches 114-120 is activated.

When the constant switch 114 is activated and the constant current switches 110, 112, 116-120 are deactivated, the predefined amount of current (e.g., around 100 mA) is drawn through the first segment, the second segment, a third segment of the LED arrays 104, and then to ground. When the constant current switches 110, 112, and 114 are deactivated, an electrical current can be routed through the first segment, second segment, and third segment of the LED arrays 104 to one or more remaining segments of the LED arrays 104, depending on which one of the constant current switches 116-120 is activated.

When the constant switch 116 is activated and the constant current switches 110-114 and 118, and 120 are deactivated, the predefined amount of current (e.g., around 100 mA) is drawn through the first segment, the second segment, the third segment, and a fourth segment of the LED arrays 104, and then to ground. When the constant current switches 110, 112, 114, and 116 are deactivated, an electrical current can be routed through the first segment, the second segment, the third segment, and the fourth segment of the LED arrays 104 to one or more of the remaining segments of the LED arrays 104, depending on which one of the constant current switches 118 and 120 is activated.

When the constant switch 118 is activated and the constant current switches 110-116 and 120 are deactivated, the predefined amount of current (e.g., around 100 mA) is drawn through the first segment, the second segment, the third segment, the fourth segment, and a fifth segment of the LED arrays 104, and then to ground. When the constant current switches 110-118 are deactivated, an electrical current can be routed through the first segment, the second segment, the third segment, the fourth segment, and the fifth segment of the LED arrays 104 to a sixth segment of the LED arrays 104, depending on whether the constant current switch 120 is activated.

When the constant switch 120 is activated and the constant current switches 110-118 are deactivated, the predefined amount of current (e.g., around 100 mA) is drawn through the first segment, the second segment, the third segment, the fourth segment, the fifth segment, and the sixth segment of the LED arrays 104, and then to ground.

At the minimum, a lighting block of the present invention can be a single LED that is connected to the input voltage and ground. Alternatively, each segment of a lighting block can comprise one or more LEDs, connected in series and/or in parallel.

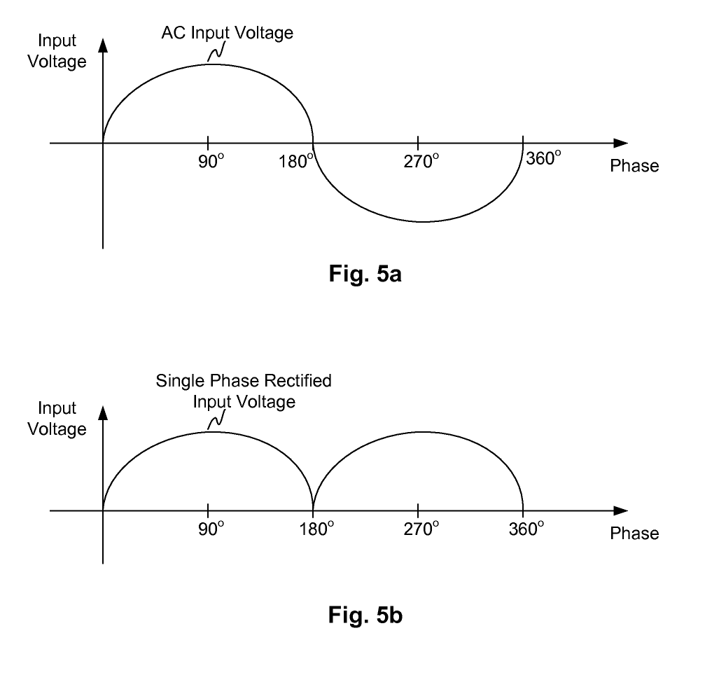

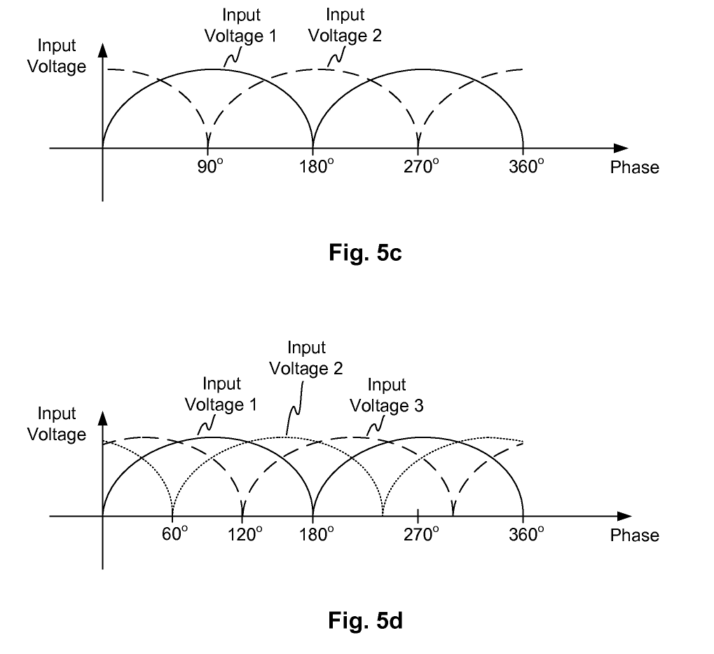

FIGS. 5a-5d illustrate various input voltages for an LED lighting system of the present invention plotted on a graph. In particular, FIG. 5a illustrates an AC input voltage plotted on a graph. In order to be used by an LED lighting system of the present invention, the AC input voltage can be rectified. FIG. 5b illustrates a single phase rectified input voltage (also referred to as a variable direct current voltage) plotted on a graph. An AC input voltage can be rectified such that there are two positive peaks in each cycle of the single phase rectified input voltage. A bridge rectifier or other equivalent circuit can receive the AC input voltage and output the single phase rectified input voltage.

FIG. 5c illustrates two rectified input voltages plotted on a graph. An LED lighting system of the present invention may have some flickering due to the voltage valleys in a single phase input voltage. Thus, in order to reduce flickering, input voltages having different phases can be applied to the LED lighting system to maintain the overall input voltage at around a certain voltage value. For instance, input voltage 1 and input voltage 2 can be applied to the LED lighting system of the present invention, where input voltage 1 and input voltage 2 have a phase difference of 90 degrees. Thus, the peak (i.e., high voltage value) of input voltage 1 occurs at the valley (i.e., low voltage value) of input voltage 2, and vice versa. The phase difference can also range anywhere from greater than 0 degrees to less than or equal to 90 degrees.

FIG. 5d illustrates three rectified input voltages plotted on a graph. In this example, three input voltages can be used to drive the LED lighting system of the present invention, where the phase difference between input voltage 1 and input voltage 2 is 60 degrees and the phase difference between input voltage 2 and input voltage 3 is 60 degrees. In other examples, the phase difference between input voltage 1 and input voltage 2 can be within the range of 0<θ<60. Also, the phase difference between input voltage 2 and input voltage 3 can be within the range of 0<θ<60. Furthermore, a multiple number of other input voltages having different phases can be used to keep the overall input voltage applied on the LED lighting system of the present invention at or about a certain voltage level to prevent flickering of the LED lighting system.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred apparatuses, methods, and systems described herein, but all those other and further alterations and modifications as would be apparent to those of ordinary skilled in the art.

We Claim:

1. An LED lighting system, comprising:
lighting blocks; and
one or more switches,
wherein electrical connections between the lighting blocks are configured using the one or more switches, and
wherein the one or more switches are operated as a function of an input voltage.

2. The LED lighting system of claim 1 wherein the lighting blocks are serially connected, and wherein each of the serial connections of the lighting blocks are connected to the input voltage via a certain one of the switches.

3. The LED lighting system of claim 2 further comprising one or more diodes, wherein the lighting blocks are serially connected via the diodes and wherein an end of each of the diodes are connected to the one or more switches.

4. The LED lighting system of claim 1 wherein the switches configure the electrical current paths to the lighting blocks.

5. The LED lighting system of claim 4 wherein when the input voltage is at a first predefined voltage, the switches are on, and wherein each of the lighting blocks receives the input voltage.

6. The LED lighting system of claim 5 wherein the lighting blocks are electrically connected in parallel.

7. The LED lighting system of claim 4 wherein when the input voltage is at a second predefined voltage, certain ones of the switches are off and other ones of the switches are on.

8. The LED lighting system of claim 7 wherein a first set of the lighting blocks are electrically connected in series, a second set of the lighting blocks are electrically connected in series, and a third set of lighting blocks are electrically connected in series, and wherein the first set, the second set, and the third set are electrically connected in parallel.

9. The LED lighting system of claim 4 wherein when the input voltage is at a third predefined voltage, a certain one of the switches is on and other ones of the switches are off

10. The LED lighting system of claim 9 wherein a first set of the lighting blocks are electrically connected in series and a second set of the lighting blocks are electrically connected in series, and wherein the first set and the second set are electrically connected in parallel.

11. The LED lighting system of claim 4 wherein when the input voltage is at a fourth predefined voltage, the switches are off.

12. The LED lighting system of claim 11 wherein the lighting blocks are electrically connected in series.

13. The LED lighting system of claim 1 wherein each of the lighting blocks comprise LED arrays and an LED control unit, wherein the LED arrays are serially-connected in segments, wherein the segments of the LED arrays are activated as a function of the input voltage to the respective lighting block, and wherein the input voltage is one or more rectified voltages.

14. The LED lighting system of claim 13 wherein the LED control unit comprises a voltage detector and control unit and constant current switches for activating certain ones of the segments of the LED arrays.

15. An LED lighting system, comprising:
one or more diodes;
lighting blocks, wherein the lighting blocks are serially connected via the diodes; and
one or more switches,
wherein an end of each of the diodes are connected to the one or more switches,
wherein electrical connections between the lighting blocks are configured using the one or more switches,
wherein each of the serial connections of the lighting blocks are connected to the input voltage via a certain one of the switches,
wherein the one or more switches are operated as a function of an input voltage, and
wherein the switches configure the electrical current paths to the lighting blocks.

16. The LED lighting system of claim 15 wherein when the input voltage is at a first predefined voltage, the switches are on, wherein each of the lighting blocks receives the input voltage, and wherein the lighting blocks are electrically connected in parallel.

17. The LED lighting system of claim 15 wherein when the input voltage is at a second predefined voltage, certain ones of the switches are off and other ones of the switches are on, wherein a first set of the lighting blocks are electrically connected in series, a second set of the lighting blocks are electrically connected in series, and a third set of lighting blocks are electrically connected in series, and wherein the first set, the second set, and the third set are electrically connected in parallel.

18. The LED lighting system of claim 15 wherein when the input voltage is at a third predefined voltage, a certain one of the switches is on and other ones of the switches are off, wherein a first set of the lighting blocks are electrically connected in series and a second set of the lighting blocks are electrically connected in series, and wherein the first set and the second set are electrically connected in parallel.

19. The LED lighting system of claim 15 wherein when the input voltage is at a fourth predefined voltage, the switches are off, and wherein the lighting blocks are electrically connected in series.

20. The LED lighting system of claim 15 wherein each of the lighting blocks comprise LED arrays and an LED control unit, wherein the LED arrays are serially-connected in segments, wherein the segments of the LED arrays are activated as a function of the input voltage to the respective lighting block, wherein the input voltage is one or more rectified voltages, and wherein the LED control unit comprises a voltage detector and control unit and constant current switches for activating certain ones of the segments of the LED arrays.

21. An LED lighting system, comprising:
one or more diodes;
lighting blocks, wherein the lighting blocks are serially connected via the diodes; and
one or more switches,
wherein an end of each of the diodes are connected to the one or more switches,
wherein electrical connections between the lighting blocks are configured using the one or more switches,
wherein each of the serial connections of the lighting blocks are connected to the input voltage via a certain one of the switches,
wherein the one or more switches are operated as a function of an input voltage,
wherein the switches configure the electrical current paths to the lighting blocks,
wherein each of the lighting blocks comprise LED arrays and an LED control unit,
wherein the LED arrays are serially-connected in segments,
wherein the segments of the LED arrays are activated as a function of the input voltage to the respective lighting block,
wherein the input voltage is one or more rectified voltages, and
wherein the LED control unit comprises a voltage detector and control unit and constant current switches for activating certain ones of the segments of the LED arrays.
